(19) United States
(12) Patent Application Publication
(10) Pub. No.: US 2002/0063165 A1
(43) Pub. Date: May 30, 2002

(54) Device for recycling condensed liquid into a gas stream

(76) Inventor: Jochen-Peter Dietl, Unterweissach (DE)

Correspondence Address: CROWELL & MORING, L.L.P., P.O. Box 14300, Washington, DC, 20044-4300, US

(21) Appl. No.: 09/983,549

(22) Filed: Oct. 24, 2001

(30) Foreign Application Priority Data
Oct. 24, 2000 (DE) 100 52 606.3

(51) Int. Cl. B05B 7/04

(52) U.S. Cl. 239/8; 239/398; 239/418; 239/429; 239/589; 239/590; 239/590.5

(57) ABSTRACT

A device for recycling a liquid that has collected on the inner wall of a tube through which a gas stream flows includes (1) a tube having an inner wall and (2) capillaries on the inner wall of the tube that project into the gas stream.

This application claims the priority of German Patent Document No. 100 52 606.3, filed on Oct. 24, 2000, the disclosure of which is expressly incorporated by reference herein.

### BACKGROUND AND SUMMARY OF INVENTION

The present invention relates to a device for recycling a liquid that has condensed on the inner walls of a tube through which a gas stream flows and for returning the condensed liquid to the gas stream.

When a gas, or an atomized liquid medium in a gas, flows through a receptacle, such as a tube, it becomes condensed at points along the inner surface of the receptacle where the temperature is below the saturation temperature for the gas. This causes droplets to form on the inside of the receptacle.

In fuel cell systems in which liquid methanol is used as the fuel, droplets tend to form along the inner surface of the tube when methanol is injected into tubes having bends in them. These droplets are released at the end of the tube as large drops. This results in higher emissions for a burner to which the tube is connected.

An object of the present invention is to provide a device that prevents the formation of larger drops of condensed liquid and recycles the condensed liquid back into the gas stream.

In accordance with preferred embodiments of the present invention, capillaries are positioned along the inner wall of a tube through which a gas flows and project outward into the gas stream. The liquid that has condensed on the inner wall of the tube is transported in the capillaries, and at the open end of the capillaries is atomized into the gas stream. This liquid may be, for example, methanol.

The liquid is transported via capillary forces in the capillaries, which usually are thin, cylindrical tubes. The level of the column of liquid ascending in the capillary is dependent upon the surface tension and the density of the liquid, and upon the diameter of the capillary. The liquid that has condensed on the inner wall of the tube is thus transported in the capillary away from the inner wall of the tube, in the direction of the open end of the capillary. At the open end of the capillary that projects out into the gas stream, the liquid becomes atomized into the gas stream.

The liquid is atomized in that the film of liquid found at the open end of the capillary is carried over by the gas stream.

The capillary effect, and thus the transport of the liquid in the capillary, is supported by the flow of gas in the tube. The flow within the cross-section of the tube results in a difference in static pressure, wherein the static pressure at the center of the tube is lower than the static pressure along the inner wall of the tube.

This pressure difference generates a vacuum in the capillaries (Venturi Effect). As the flow rate within the tube increases, the difference in static pressure between the center of the tube and the inner wall of the tube also increases. This causes correspondingly larger quantities of liquid to be transported within the capillaries and recycled back into the gas stream.

One advantage of the device according to preferred embodiments of the present invention is that the atomized liquid can be more rapidly vaporized in the gas stream.

A further advantage of the device according to preferred embodiments the present invention is that the recycling of the liquid into the gas stream is automatically adjusted by the vacuum that is formed in the capillaries, based upon the volume of the gas stream and the flow rate of the gas.

To the extent that physical boundary conditions, the difference in static pressure, and the boiling point and viscosity of the liquid permit, a recycling of liquid back into a gas stream is possible at temperatures below 0° C.

In one advantageous embodiment of the present invention, the condensed liquid can be collected in the area around the capillaries on the inner wall of the tube, for example, in a groove along the inner wall of the tube.

The capillaries may especially be aligned perpendicular to the direction of flow of the gas stream. With such an arrangement, the Venturi Effect is intensified, causing the vacuum effect in the capillaries to increase.

The capillaries may advantageously be positioned in a symmetrically circular arrangement, such as a coronal arrangement, and aligned in the direction of the center point of the tube. This will result in an even distribution of the atomized liquid in the gas stream.

By varying the length of the capillaries by up to half the average diameter of the tube, and by varying the diameter of the individual capillaries, the distribution of the atomized liquid in terms of an even distribution within the gas stream can be further improved. It is possible, for example, to design long capillaries having a diameter that is greater than that of shorter capillaries.

In one advantageous embodiment of the present invention, the capillaries may be positioned in a single section of tube. The diameter of this section of tube may advantageously be smaller than that of the tubing, creating a gap between the section of tube and the tubing. The condensed liquid can be collected in this gap. The section of tube can then be inserted modularly into the tubing, preferably at points within the tubing at which liquid tends to condense the most, for example, in or near bends or branches from the tube.

The gap may also be closed off in the direction of flow, at the end of the tube section, so that condensed liquid can be collected in the gap.

One application of the device according to the present invention is for use as a methanol atomizer in fuel cell systems for mobile applications.

Other objects, advantages and novel features of the present invention will become apparent from the following detailed description of the present invention when considered in conjunction with the accompanying drawings.

### BRIEF DESCRIPTION OF THE DRAWINGS

FIG. 1 shows an arrangement of capillaries inside a tube according to a preferred embodiment of the present invention; and

FIG. 2 shows a longitudinal cross-section of tubing containing an inserted section of tube in which capillaries are positioned.

### DETAILED DESCRIPTION OF THE DRAWINGS

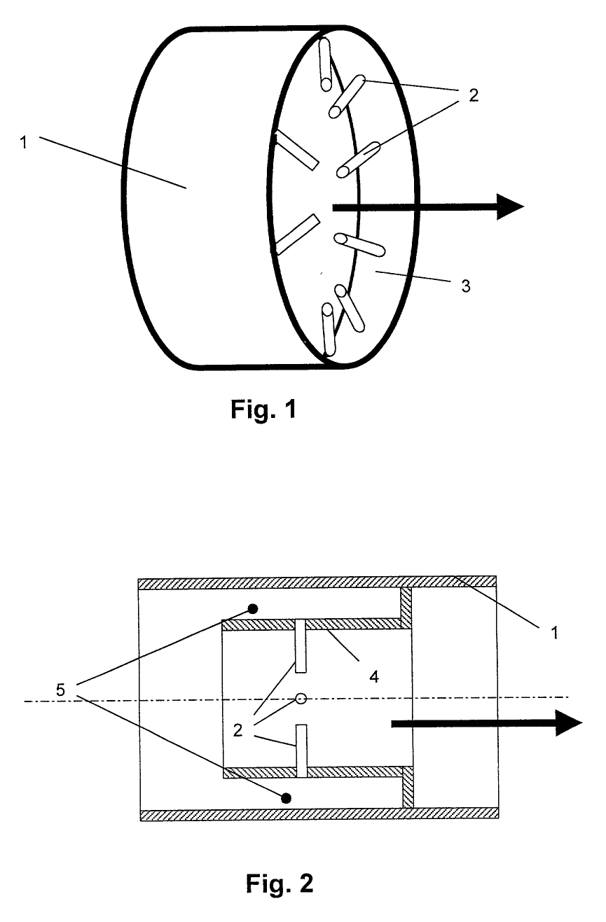

FIG. 1 shows an arrangement of capillaries 2 in a tube 1, through which a gaseous medium flows. The capillaries 2 are usually thin, cylindrical tubes.

On the inner wall of the tube 1, a groove 3 is provided, in which the liquid that has condensed on the inner wall of the tube 1 collects, and can be fed to the capillaries 2.

The capillaries 2 are positioned in a symmetrically circular arrangement on the inner surface of the tube 1, around the entire inner circumference of the tube 1, and are oriented in the direction of the center point of the tube. The capillaries 2 are mounted in the groove 3 on the inner wall of the tube 1. The capillaries 2 may be mounted via plasma jet welding, or via curing shrinkage, pressing, gluing, squeezing, friction welding, spot welding, or welding in an inert gas.

The liquid is forced through the capillary opening that faces the inner wall of the tube into the capillaries 2. This accomplished, for example, in that the capillaries 2 are mounted on the inner wall of the tube only at certain sections around the circumference of the capillary opening, leaving a passage between the groove 3 and the space inside the capillary 2, through which the liquid can enter the capillary 2. Further, a certain linear section of the capillaries 2, preferably in the area of the inner wall of the tube, may be designed to be porous.

The capillaries 2 may also be arranged in several rows, aligned in the direction of the flow of gas and covering a large area along the inner wall of the tube. In a further embodiment, the capillaries 2 are provided only at certain sections around the circumference of the tube 1, for example, only in the lower area of the section of tube to which the condensed liquid tends to flow by force of gravity.

FIG. 2 shows a longitudinal section of tubing 1 containing an inserted section of tube 4, with the capillaries 2 being positioned in the section of tube 4 in accordance with an embodiment of the present invention. The section of tube 4 is smaller in diameter than the tubing 1, forming an annular gap 5 between the section of tube 4 and the tubing 1. This gap 5 may be closed off at the end of the section of tube 4, viewed in the direction of flow. The condensed liquid collects in the gap 5. The gap 5 becomes filled with liquid. This causes a large quantity of liquid to be transported into the gas stream through the capillaries 2.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within scope of the present invention.

What is claimed is:

1. A device for recycling a liquid that has condensed on the inner wall of a tube, comprising:
a tube through which a gas stream flows and having an inner wall on which liquid is condensed; and
capillaries positioned on the inner wall of the tube and projecting into the gas stream.

2. A device in accordance with claim 1, further comprising a groove on the inner wall of the tube in which the condensed liquid can be collected.

3. A device according to claim 1, wherein the capillaries are aligned perpendicular to a direction of flow of the gas stream.

4. A device according to claim 3, wherein the capillaries are aligned in a symmetrical circle in a direction of a center point of the tube.

5. A device according to claim 1, wherein a length of the capillaries is varied to achieve homogeneous distribution of the condensed liquid in the gas stream.

6. A device according to claim 1, wherein a length of the capillaries is a maximum of half the average diameter of the tube.

7. A device according to claim 1, wherein the capillaries are positioned in a single section of tube, which is inserted modularly in an existing section of tube, thereby creating a gap between the single section of tube and the tube in which the condensed liquid can be collected.

8. A device according to claim 7, wherein the gap is closed off at an end of the single section of tube.

9. A method for recycling condensed liquid in a tube, comprising:
condensing liquid on an inner wall of a tube through which a gas stream flows; and
transporting liquid through capillaries positioned on the inner wall of the tube and projecting into the gas stream; and
atomizing the liquid at an open end of the capillaries, thereby recycling the condensed liquid into the gas stream.

10. A method according to claim 9, further comprising collecting the condensed liquid in a groove along the inner wall of the tube.

11. A method according to claim 10, further comprising adjusting at least one of a flow rate of the gas stream or a volume of the gas stream, thereby adjusting the recycling of the condensed liquid.

12. A method according to claim 9, wherein the recycling of the condensed liquid is at a temperature less than 0° C.
